(19) United States
(12) Patent Application Publication
(10) Pub. No.: US 2008/0116137 A1
(43) Pub. Date: May 22, 2008

(54) MONOLITHIC ORGANIC COPOLYMER

(75) Inventors: Gunther Bonn, Zirl (AT); Said Lubbad, Gaza (IL); Clemens P. Bisjak, Innsbruck (AT)

Correspondence Address: WORKMAN NYDEGGER, 60 EAST SOUTH TEMPLE, 1000 EAGLE GATE TOWER, SALT LAKE CITY, UT, 84111, US

(73) Assignee: Leopold-Franzens-Universitat Innsbruck, Innsbruck (AT)

(21) Appl. No.: 11/562,895

(22) Filed: Nov. 22, 2006

(51) Int. Cl. B01D 15/08; C08J 3/09

(52) U.S. Cl. 210/656; 210/198.2; 524/113

(57) ABSTRACT

Monolithic organic copolymer prepared by copolymerisation of a phenyl (meth)acrylate and a phenylene di(meth)acrylate in the presence of a porogen, wherein said copolymerisation is carried out at a temperature of at least 70° C. This polymer can be used as chromatographic material for separating biopolymers and small molecules.

### BACKGROUND OF THE INVENTION

1. Field of the Invention

The present invention is referred to a monolithic organic copolymer prepared by copolymerisation of an aromatic (meth)acrylate and an aromatic di(meth)acrylate in the presence of a porogen. Further, the present invention is aimed at a method for separating biopolymers, employing high-performance liquid chromatography, wherein the named organic monolithic polymer is used as separation medium. In addition to that, the present invention is also directed to a capillary column for high-performance liquid chromatography.

2. Background

Generally, monoliths can be described as a single block of structured material containing lots of interconnected channels [1]. This permanent channel network consisting of macro- and mesopores distributed uniformly across the whole structure, is built up as the result of phase separation occurring during the polymerisation process of monomers in the presence of inert diluents (porogens) within the confines of an unstirred mold. Due to their unique structure, monolithic separation media possess some major advantages in comparison to their particle packed analogues. Erasure of interparticular void volume, which forces the solvent to flow through the open channel network at moderate back pressure and the resulting advantageous mass transfer characteristics, enable fast and highly efficient separations, especially of large biopolymers [2]. Since both, pressure drop and specific surface area highly depend on the dimension of the pores, formed during the polymerisation process, tailoring the porous structure of monolithic supports represents one of the main challanges to obain the desired chromatographic properties. The most frequently used tool for fine-tuning of the porous properties is the choice of the pore-forming agent (porogen) [3,4]. Additionally, polymerisation temperature and the amount of cross-linking monomer and initiator are known to be efficient parameters to significantly affect the porous properties of the resulting monolith [5].

During the last 10 years, a broad variety of monomers has been introduced for the preparation of monolithic supports. Beside silica-based monoliths, prepared by a sol-gel process, the most common organic materials were developed on the basis of methacrylate [6,7] and styrene [8,9] monomers. Additionally, monoliths prepared by ring-opening metathesis polymerisation (ROMP) have been successfully applied to the separation of biopolymers [10].

An acrylate-based monolithic material for chromatographic support, prepared at a polymerisation temperature of 65° C., has been described in the prior art [11].

### SUMMARY OF INVENTION

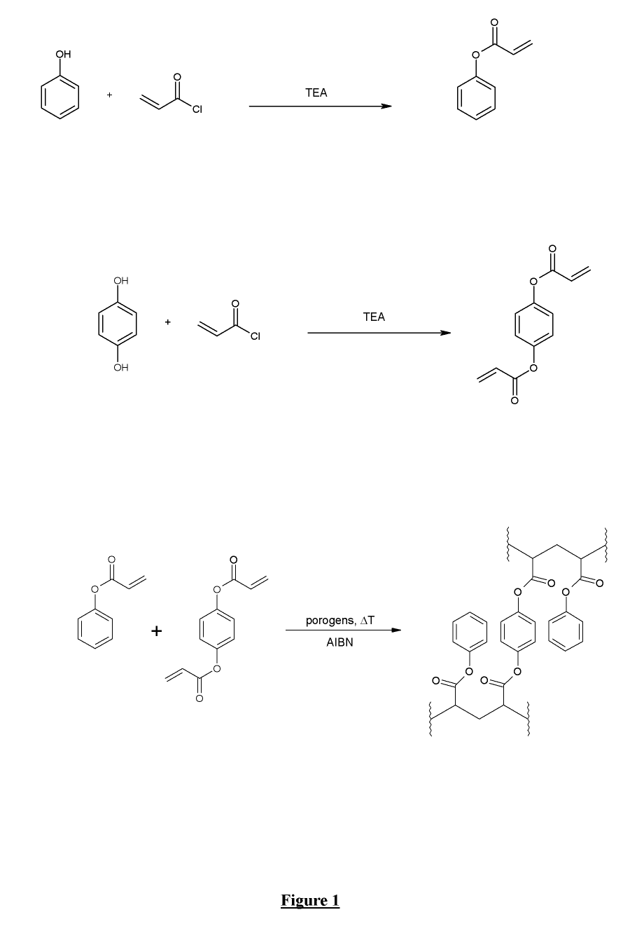

A novel monolithic copolymer, based on the aromatic precursors phenyl(meth)acrylate and 1,4-phenylene di(meth)acrylate, is prepared by copolymerisation at a temperature of at least 70° C., in the presence of an inert diluent (porogen), preferably using α,α′-azoisobutyronitrile (AIBN) as initiator (See reaction scheme in FIG. 1).

A preferred embodiment concerning the novel monolithic copolymer can be fabricated by using a porogen which consists of 2-propanol and tetrahydrofuran (THF).

The porogen is preferably contained in the polymerisation mixture within the range of 61-65 percent by weight (wt.-%), with the rest being phenyl(meth)acrylate and 1,4-phenylene di(meth)acrylate.

THF is preferably contained in the polymerisation mixture within a preferred range of 10-16 wt.-% with the rest being 2-propanol, phenyl(meth)acrylate and 1,4-phenylene di(meth)acrylate.

The monolithic organic copolymer can be in the form of particles having a diameter in the range of 2-50 μm.

The invention is further directed to a method for separating biopolymers or small molecules (<250 Dalton) using high-performance liquid chromatography, characterised in that as stationary phase the monolithic copolymer as mentioned above is used.

The invention is also directed to capillary columns for high-performance liquid chromatography containing a monolithic organic polymer, wherein said monolithic organic polymer is a copolymer according to the present invention.

### DETAILED DESCRIPTION OF PREFERRED EMBODIMENTS

Preferred monolithic capillary columns are prepared by thermally initiated free radical copolymerisation of phenyl acrylate (PA) and 1,4-phenylene diacrylate (PDA) in the presence of 2-propanol and THF (FIG. 1). Polymerisation is initiated by α,α′-azoisobutyronitrile (AIBN). Protocols for the synthesis of PA [12] and PDA [13] that can be found in literature were adopted and modified as described in Example 1.

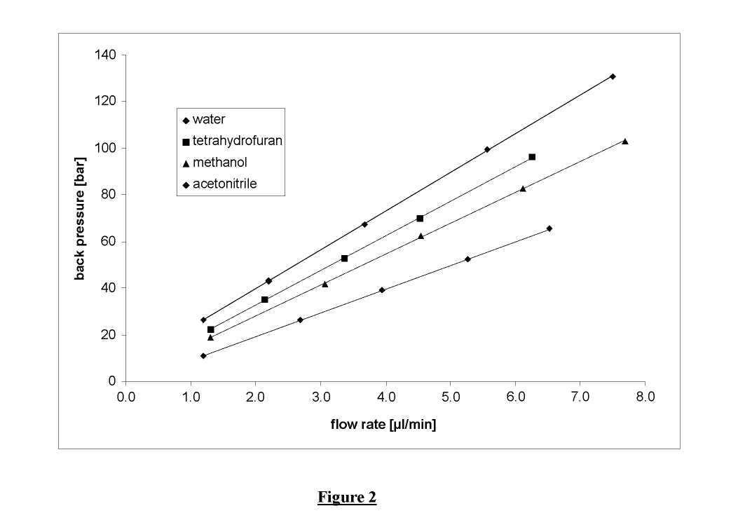

In order to evaluate the mechanical stability and the swelling behavior of a typical monolithic PA/PDA capillary column, the pressure drop per flow rate was measured for 4 different solvents, namely, water, THF, methanol and acetonitrile. As the graphs in FIG. 2 demonstrate, a high linear dependence (R²>0.9998 for all utilised solvents) between pressure drop and flow rate was observed. This indicates a high mechanical stability of the monolithic material. Except THF which caused slight swelling (SP-Factor of 0.73, [14]), the capillary monolith showed high resistance to swell in organic solvents.

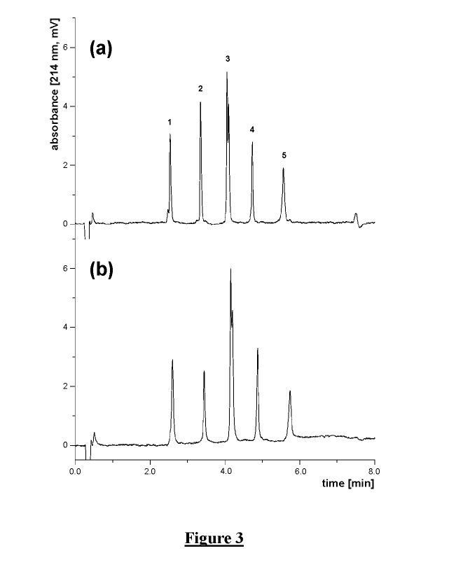

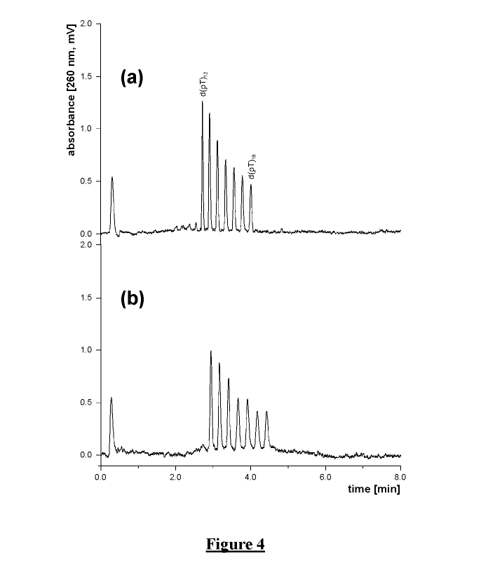

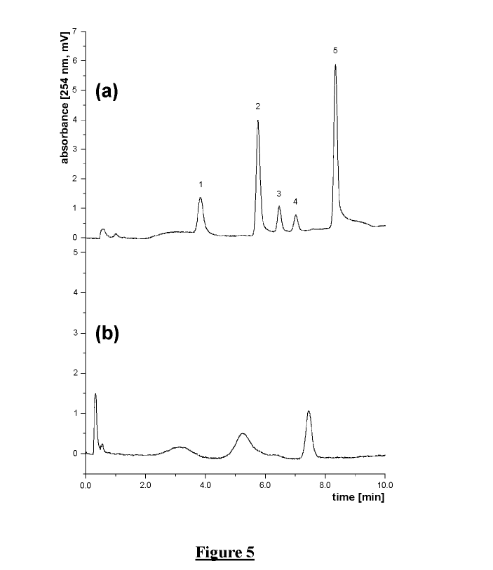

It turned out that the composition and amount of the porogen, as well as the polymerisation temperature are the key variables to change, when optimising the porous structure monolithic materials. In the case of monolithic PA/PDA it was found out, that raising the polymerisation temperature from 65 to at least 70° C. had a significant impact on the chromatographic performance of the resulting monolithic organic copolymer, concerning the separation of (1) proteins, (2) oligonucleotides and (3) small molecules like phenols.
(1) The separations of standard proteins (ribonuclease A, cytochrome c, α-lactalbumin, β-lactoglobulin B and ovalbumin) on a monolith prepared at 70° C. and on a second monolith prepared at 65° C., employing identical reversed-phase (RP) conditions, are illustrated in FIG. 3. Comparing the obtained chromatographic data, like retention times (t_{R}), peak widths at half height (b_{0.5}) and resolution (R), a higher efficiency can be observed for the monolith prepared at 70° C.
(2) The separations of an oligonucleotide standard [d(pT)₁₂₋₁₈] on a monolith prepared at 70° C. and on a second monolith prepared at 65° C., employing identical ion-pair reversed-phase (IP-RP) conditions, are illustrated in FIG. 4. It can clearly be seen, that values for b_{0.5} and R are significantly improved when employing the monolithic capillary prepared at 70° C.
(3) As a representant of small molecules, known to be challenging to separate, phenols (phenol, 4-nitrophenol, 2-chlorphenol, 2,4-dimethylphenol, 2-nitrophenol) were injected onto monolithic PA/PDA capillary monoliths prepared at 70 and 65° C. and separated using RP conditions. As it can be deduced from the chromatograms depicted in FIG. 5, the monolith fabricated at 65° C. was completely ineffective concerning the fractionation of phenols, whereas baseline separation could be achieved enploying the monolith prepared at 70° C.

The favourable chromatographic properties obtained at a polymerisation temperature of at least 70° C. can be attributed to the fact, that a more dense polymer network, consisting of pores having smaller dimensions and hence a higher specific surface area, is formed.

### EXAMPLE 1

A reaction scheme illustrating the synthesis of phenyl acrylate (PA) and 1,4-phenylene diacrylate (PDA), as well as the copolymerisation of the named compounds is shown in FIG. 1.

PA used as a monomer for the preparation of PA/PDA monoliths can be prepared as follows: To a solution of phenol (15.0 g, 160 mmol) and triethylamine (25.4 ml, 180 mmol) in THF (150 ml), acryloyl chloride (14.72 ml, 180 mmol) is added dropwise over a period of 15 min at room temperature (RT) under nitrogen. After 3 h of stirring, triethylammonium chloride is removed by filtration and the solvent is evaporated. The residue is dissolved in ether and extracted with 5% acetic acid, deionised water and saturated solution of NaHCO₃. The organic phase is dried over Na₂SO₄, the solvent is evaporated and the crude product finally distilled under vacuo to yield phenyl acrylate as an oily colorless product (13.8 ml, 62.5%). The purity of the product is checked and confirmed by ¹H-NMR and ¹³C-NMR. PDA used as a crosslinker for the preparation of PA/PDA monoliths can be prepared as follows: Acryloyl chloride (14.7 ml, 180 mmol) is added dropwise over a period of 15 min to a solution of hydroquinone (8.82 g, 80 mmol) and triethylamine (25.4 ml, 180 mmol) in THF (150 ml) at RT under nitrogen. After stirring for 4 h, triethylammonium chloride is removed by filtration, the solvent is evaporated and the residue is dissolved in ether. The ethereal solution is extracted with 5% acetic acid, deionised water, saturated solution of NaHCO₃ and dried over Na₂SO₄. Ether is removed and the crude product finally purified by column chromatography (n-hexane/ethyl acetate 3:1) to yield 1,4-phenylene diacrylate as white plates (12.2 g, 70%). The purity of the product is checked and confirmed by ¹H-NMR and ¹³C-NMR.

A monolithic PA/PDA copolymer can be prepared by thermally initiated free radical polymerisation of PA and PDA in the presence of an inert diluent (porogen) using α,α′-azoisobutyronitrile (AIBN) as initiator (Examples 2, 3 and 5).

### EXAMPLE 2

To enable the covalent attachment of the monolith, the inner wall of 200 μm I.D. fused silica capillaries is silanised according to a protocol that can be found in literature [15]. Synthesis of a PA/PDA capillary column: 5 mg AIBN and 95 mg PDA are weighed out into a glass vial. 88.3 μl PA, 318.5 μl 2-propanol and 67.65 μl THF are added. The sealed vial is sonicated in a sonication bath at 40° C. for 10 minutes to obtain a clear homogeneous solution. This solution is filled in a preheated, 200 μm I.D., silanised fused silica capillary using a warmed syringe. Polymerisation is allowed to proceed for 24 h at 70° C. in a water bath.

After polymerisation, the resulting monolith is flushed with acetonitrile, using an air pressure driven pump, to remove the porogen and unreacted monomers. Finally the capillary is cut to receive a monolith of 7.5 cm of length. Following, the monolith is connected to a HPLC pump that is then driven with four different solvents (water, THF, methanol and acetonitrile) at room temperature (RT) to evaluate the mechanical stability of the material. The flow is split by the use of a T-piece, which is placed between the pump and the monolith, and controlled using a restriction capillary. The graphs obtained for the relationship between applied flow rate and resulting back pressure are shown in FIG. 2.

The resulting graphs depicted in FIG. 2 prove an excellent linear dependence between pressure drop and flow rate (R²>0.9998 for all graphs), demonstrating high pressure resistance of the support even at high flow rates. According to Darcy's law (eq. 1),

$$Δ p = \frac{u \cdot η \cdot L}{{B}_{0}} \qquad \text{(eq. 1)}$$

(where Δp is the pressure drop, u the linear flow velocity, η the viscosity of the solvent, L the length of the capillary and B₀ the permeability) the back pressure—considering a given column design—only depends on the viscosity of the utilised solvent, provided that the flow rate is kept constant. Back pressure is thus expected to decrease in the order H₂O>MeOH>THF>ACN. As it can be deduced from FIG. 2, THF, known as an excellent solvent for organic polymers, causes slight swelling of the PA/PDA monolith. Nevertheless, swelling in THF is low, indicated by a swelling propensity (SP) factor [14] of 0.73. ACN, MeOH and water give the expected order in back pressure.

### EXAMPLE 3

(a) Preparation of a First Monolith:

5 mg AIBN and 95 mg PDA are weighed out into a glass vial. 88.3 μl PA, 318.5 μl 2-propanol and 67.65 μl THF are added. The sealed vial is sonicated in a sonication bath at 40° C. for 10 minutes to obtain a clear homogeneous solution. This solution is filled in a preheated, 200 μm I.D., silanised fused silica capillary using a warmed syringe. Polymerisation is allowed to proceed for 24 h at 70° C. in a water bath. After polymerisation, the resulting monolith is flushed with acetonitrile, using an air pressure driven pump, to remove the porogen and unreacted monomers. Finally the capillary is cut to its final length of 7.5 cm.

In the following, this monolith is called monolith 1.

(b) Preparation of a Second Monolith:

5 mg AIBN and 97.5 mg PDA are weighed out into a glass vial. 90.6 μl PA, 312.1 μl 2-propanol and 67.65 μl THF are added. The sealed vial is sonicated in a sonication bath at 40° C. for 10 minutes to achieve a clear homogeneous solution. This solution is filled in a preheated, 200 μm I.D., silanised fused silica capillary using a warmed syringe. Polymerisation is allowed to proceed for 24 h at 65° C. in a water bath. After polymerisation, the resulting monolith is flushed with acetonitrile, using an air pressure driven pump, to remove the porogen and unreacted monomers. Finally the capillary is cut to its final length of 7.5 cm.

In the following, this monolith is called monolith 2.

Monolith 1 and 2 are attached to a micro-LC system consisting of a micropump, a 10 way injection valve, a UV/Vis bubble cell detector and a degasser. The primary flow is reduced by employing a T-piece with an integrated restriction capillary, mounted between micropump and injection valve. The resulting secondary flow rate is determined at the column exit. Injection volume is 500 nl.

Using the described system, a protein mixture, consisting of ribonuclease A, cytochrome c, α-lactalbumin, β-lactoglobulin B and ovalbumin, is separated on monolith 1 and 2, employing identical reversed-phase (RP) conditions (FIG. 3a and b): mobile phase A: 0.1% trifluoroacetic acid (TFA), mobile phase B: 0.1% TFA in acetonitrile (ACN); gradient, 10-65% B in 8 min; flow rate, 12.5 μl/min; temperature, 50° C.; detection, UV 214 nm; peak identification: (1) ribonuclease A, (2) cytochrome c, (3) α-lactalbumin, (4) β-lactoglobulin B and (5) ovalbumin, 80 fmol each.

The resulting separations, performed on monolith 1 and 2 are illustrated in FIG. 3a and b, respectively. As it can be concluded from the chromatograms, the analytes are easily separated on both capillary columns. Nevertheless, monolith 1 provides higher separation efficiency as it can be derived from Table 1, in which chromatographic data like retention times (t_{R}), peak widths at half height (b_{0.5}) and resolution (R) are summarised.

### EXAMPLE 4

Monolith 1 and 2 (Example 3) are attached to a micro-LC system consisting of a micropump, a 10 way injection valve, a UV/Vis bubble cell detector and a degasser. The primary flow is reduced by employing a T-piece with an integrated restriction capillary, mounted between micropump and injection valve. The resulting secondary flow rate is determined at the column exit. Injection volume is 500 nl.

Using the described system, an oligonucleotide standard [d(pT)₁₂₋₁₈] is separated on monolith 1 and 2, employing identical ion-pair reversed-phase (IP-RP) conditions (FIG. 4a and b): mobile phase A: 0.1 M triethylammonium acetate (TEAA), mobile phase B: 0.1 M TEAA in 40% ACN; gradient, 0-15% B in 1 min, 15-30% B in 7 min; flow rate, 12.5 μl/min; temperature, 50° C.; detection, UV 260 nm; sample: d(pT)₁₂₋₁₈, 90 fmol each.

The resulting separations, performed on monolith 1 and 2 are illustrated in FIG. 4a and b, respectively. As it can be concluded from the chromatograms, monolith 1 provides higher separation efficiency in terms of peak width at half height (b_{0.5}) and hence resolution (R). Chromatographic data are summarised in Table 2.

### EXAMPLE 5

Preparation of a Third Monolith:

5 mg AIBN and 87.5 mg PDA are weighed out into a glass vial. 81.3 μl PA, 312.1 μl 2-propanol and 90.2 μl tetrahydrofuran THF are added. The sealed vial is sonicated in a sonication bath at 40° C. for 10 minutes to achieve a clear homogeneous solution. This solution is filled in a preheated, 200 μm I.D., silanised fused silica capillary using a warmed syringe. Polymerisation is allowed to proceed for 24 h at 70° C. in a water bath. After polymerisation, the resulting monolith is flushed with acetonitrile, using an air pressure driven pump, to remove the porogens and unreacted monomers. Finally the capillary is cut to its final length of 7.5 cm.

In the following, this monolith is called monolith 3.

Monolith 2 (Example 3) and 3 are attached to a micro-LC system consisting of a micropump, a 10 way injection valve, a UV/Vis bubble cell detector and a degasser. The primary flow is reduced by employing a T-piece with an integrated restriction capillary, mounted between micropump and injection valve. The resulting secondary flow rate is determined at the column exit. Injection volume is 500 nl.

Using the described system, a mixture of phenols (phenol, 4-nitrophenol, 2-chlorophenol, 2,4-dimethylphenol, 2-nitrophenol) is injected on monolith 2 and 3 and separated employing reversed-phase (RP) conditions (FIG. 5a and b): mobile phase A: 0.1% TFA, mobile phase B: 0.1% TFA in ACN; gradient, 0-50% B in 10 min; flow rate, (a) 5.6 μl/min, (b) 8.3 μl/min; temperature, 50° C.; detection, UV 254 nm; peak identification (1) phenol, (2) 4-nitrophenol, (3) 2-chlorophenol, (4) 2,4-dimethylphenol, (5) 2-nitrophenol; 20 ppm each compound.

The positive effect of raising the polymerisation temperature is documented by the ability of fractionating small molecules like phenols. Whereas monolith 2 is completely ineffective regarding the separation of a phenol standard (FIG. 5b), monolith 3 enables baseline separation of all 5 compounds (FIG. 5a).

TABLE 1

| Monolith 1 | | | | Monolith 2 | | | |
|---|---|---|---|---|---|---|---|
| compound | t_{R} [min] | b_{0.5} [min] | R | compound | t_{R} [min] | b_{0.5} [min] | R |
| Ribonuclease A | 2.533 | 0.047 | 11.05 | Ribonuclease A | 2.587 | 0.053 | 9.68 |
| Cytochrome c | 3.347 | 0.040 | 7.28 | Cytochrome c | 3.437 | 0.050 | 5.97 |
| α-Lactalbumin | 4.058 | 0.075 | 7.10 | α-Lactalbumin | 4.147 | 0.090 | 5.88 |
| β-Lactoglobulin B | 4.732 | 0.037 | 9.95 | β-Lactoglobulin B | 4.863 | 0.053 | 7.65 |
| Ovalbumin | 5.563 | 0.062 | | Ovalbumin | 5.730 | 0.080 | |

TABLE 2

| Monolith 1 | | | | Monolith 2 | | | |
|---|---|---|---|---|---|---|---|
| | | b_{0.5} | | | | b_{0.5} | |
| compound | t_{R} [min] | [min] | R | compound | t_{R} [min] | [min] | R |
| d(pT)₁₂ | 2.705 | 0.040 | 2.77 | d(pT)₁₂ | 2.925 | 0.053 | 2.35 |
| d(pT)₁₃ | 2.897 | 0.042 | 2.69 | d(pT)₁₃ | 3.155 | 0.062 | 2.26 |
| d(pT)₁₄ | 3.103 | 0.048 | 2.73 | d(pT)₁₄ | 3.395 | 0.063 | 2.26 |
| d(pT)₁₅ | 3.327 | 0.048 | 2.59 | d(pT)₁₅ | 3.648 | 0.068 | 2.16 |
| d(pT)₁₆ | 3.547 | 0.052 | 2.56 | d(pT)₁₆ | 3.905 | 0.072 | 2.06 |
| d(pT)₁₇ | 3.772 | 0.052 | 2.48 | d(pT)₁₇ | 4.162 | 0.075 | 2.00 |
| d(pT)₁₈ | 3.997 | 0.055 | | d(pT)₁₈ | 4.417 | 0.075 | |

### REFERENCES

[1] G. Jas, A. Kirschning, Chem. Eur. J. 9 (2003) 5708.
[2] E. C. Peters, F. Svec, J. M. J. Fréchet, Adv. Mater. 11 (1999) 1169.
[3] C. Viklund, F. Svec, J. M. J. Fréchet, Chem. Mater. 8 (1996) 744.
[4] B. P. Santora, M. R. Gagne, K. G. Moloy, N. S. Radu, Macromolecules 34 (2001) 658.
[5] F. Svec, J. M. J. Fréchet, Chem. Mater. 7 (1995) 707.
[6] D. Lee, F. Svec, J. M. J. Fréchet, J. Chromatogr. A 1051 (2004) 53.
[7] M. Merhar, A. Podgomik, M. Barut, M. Zigon, A. Strancar, J. Sep. Sci. 26 (2003) 322.
[8] I. Gusev, X. Huang, C. Horváth, J. Chromatogr. A 855 (1999) 273.
[9] A. Premstaller, H. Oberacher, W. Walcher, A. M. Timperio, L. Zolla, J.-P. Chervet, N. Cavusoglu, A. van Dorsselaer, C. G. Huber, Anal. Chem. 73 (2001) 2390.
[10] B. Mayr, R. Tessadri, E. Post, M. R. Buchmeiser, Anal. Chem. 73 (2001) 4071.
[11] C. P. Bisjak, S. H. Lubbad, L. Trojer, B. G. K., abstract, 8th International symposium on “Polymers for advanced technologies”, Budapest (May 2005).
[12] M. Shi, C.-Q. Li, J.-K. Jiang, Molecules 7 (2002) 721.
[13] L. Li, H. Hayakawa, K. Yonetake, M. Ueda, Macromol. Chem. Phys. 201 (2000) 1667.
[14] F. Nevejans, M. Verzele, J. Chromatogr. 350 (1985) 145.
[15] C. P. Bisjak, R. Bakry, C. W. Huck, G. K. Bonm, Chromatographia 62 (2005) 31.

1. Monolithic organic copolymer prepared by copolymerization of a phenyl(meth)acrylate and a phenylene di(meth)acrylate in the presence of a porogen, wherein said copolymerization is carried out at a temperature of at least 70° C.

2. Monolithic organic copolymer according to claim 1, wherein said porogen is a mixture of 2-propanol and tetrahydrofuran.

3. Monolithic organic copolymer prepared by copolymerization of a phenyl(meth)acrylate and a phenylene di(meth)acrylate in the presence of a porogen according to claim 1, wherein said porogen is present in the copolymerization mixture in an amount within the range of about 61-65 percent by weight (wt.-%) with the rest being said phenyl(meth)acrylate and said phenylene di(meth)acrylate.

4. Monolithic organic copolymer prepared by copolymerization of a phenyl(meth)acrylate and a phenylene di(meth)acrylate in the presence of a porogen according to claim 1, wherein said porogen comprises tetrahydrofuran which is present in the copolymerization mixture in an amount within the range of about 10-16 wt.-% with the rest being 2-propanol, said phenyl(meth)acrylate and said phenylene di(meth)acrylate.

5. Monolithic organic copolymer according to claim 1, wherein said phenylene di(meth)acrylate is 1,4-phenylene di(meth)acrylate.

6. Monolithic organic copolymer according to claim 1, wherein said copolymerization is a thermally initiated free radical copolymerization.

7. Monolithic organic copolymer according to claim 1 in the form of particles having a diameter in the range of about 2-50 μm.

8. Capillary columns for high-performance liquid chromatography containing a monolithic organic polymer, wherein said monolithic organic polymer is a copolymer prepared by copolymerization of a phenyl(meth)acrylate and a phenylene di(meth)acrylate in the presence of a porogen, wherein said copolymerization is carried out at a temperature of at least 70° C.

9. A method for separating biopolymers using high performance liquid chromatography, the method comprising:
as stationary phase, using a monolithic organic polymer prepared by copolymerization of a phenyl(meth)acrylate and a phenylene di(meth)acrylate in the presence of a porogen, wherein said copolymerization is carried out at a temperature of at least 70° C.

10. A method for separating small molecules using high performance liquid chromatography, the method comprising:
as stationary phase, using a monolithic organic polymer prepared by copolymerization of a phenyl(meth)acrylate and a phenylene di(meth)acrylate in the presence of a porogen, wherein said copolymerization is carried out at a temperature of at least 70° C.

11. The capillary columns according to claim 8, wherein said porogen is a mixture of 2-propanol and tetrahydrofuran.

12. The capillary columns according to claim 8, wherein the monolithic organic copolymer is prepared by copolymerization of a phenyl(meth)acrylate and a phenylene di(meth)acrylate in the presence of a porogen, said porogen being present in the copolymerization mixture in an amount within the range of about 61-65 percent by weight (wt.-%) with the rest being said phenyl(meth)acrylate and said phenylene di(meth)acrylate.

13. The capillary columns according to claim 8, wherein the monolithic organic copolymer is prepared by copolymerization of a phenyl(meth)acrylate and a phenylene di(meth)acrylate in the presence of a porogen, said porogen comprising tetrahydrofuran which is present in the copolymerization mixture in an amount within the range of about 10-16 wt.-% with the rest being 2-propanol, said phenyl(meth)acrylate and said phenylene di(meth)acrylate.

14. The capillary columns according to claim 8, wherein said phenylene di(meth)acrylate is 1,4-phenylene di(meth)acrylate.

15. The capillary columns according to claim 8, wherein said copolymerization is a thermally initiated free radical copolymerization.

16. The capillary columns according to claim 8, wherein the monolithic organic copolymer is in the form of particles having a diameter in the range of about 2-50 μm.

17. The method according to claim 9, wherein said step of using a monolithic organic polymer includes a porogen having a mixture of 2-propanol and tetrahydrofuran.

18. The method according to claim 9, wherein said step of using a monolithic organic polymer includes a copolymer prepared by copolymerization of a phenyl(meth)acrylate and a phenylene di(meth)acrylate in the presence of a porogen, said porogen being present in the copolymerization mixture in an amount within the range of about 61-65 percent by weight (wt.-%) with the rest being said phenyl(meth)acrylate and said phenylene di(meth)acrylate.

19. The method according to claim 9, wherein said step of using a monolithic organic polymer includes a copolymer prepared by copolymerization of a phenyl(meth)acrylate and a phenylene di(meth)acrylate in the presence of a porogen, said porogen comprising tetrahydrofuran which is present in the copolymerization mixture in an amount within the range of about 10-16 wt.-% with the rest being 2-propanol, said phenyl(meth)acrylate and said phenylene di(meth)acrylate.

20. The method according to claim 9, wherein said step of using a monolithic organic polymer includes a phenylene di(meth)acrylate being 1,4-phenylene di(meth)acrylate.

21. The method according to claim 9, wherein said step of using a monolithic organic polymer includes a copolymerization being a thermally initiated free radical copolymerization.

22. The method according to claim 9, wherein said step of using a monolithic organic polymer includes a copolymer in the form of particles having a diameter in the range of about 2-50 μm.

23. The method according to claim 10, wherein said step of using a monolithic organic polymer includes a porogen having a mixture of 2-propanol and tetrahydrofuran.

24. The method according to claim 10, wherein said step of using a monolithic organic polymer includes a copolymer prepared by copolymerization of a phenyl(meth)acrylate and a phenylene di(meth)acrylate in the presence of a porogen, said porogen being present in the copolymerization mixture in an amount within the range of about 61-65 percent by weight (wt.-%) with the rest being said phenyl(meth)acrylate and said phenylene di(meth)acrylate.

25. The method according to claim 10, wherein said step of using a monolithic organic polymer includes a copolymer prepared by copolymerization of a phenyl(meth)acrylate and a phenylene di(meth)acrylate in the presence of a porogen, said porogen comprising tetrahydrofuran which is present in the copolymerization mixture in an amount within the range of about 10-16 wt.-% with the rest being 2-propanol, said phenyl(meth)acrylate and said phenylene di(meth)acrylate.

26. The method according to claim 10, wherein said step of using a monolithic organic polymer includes a phenylene di(meth)acrylate being 1,4-phenylene di(meth)acrylate.

27. The method according to claim 10, wherein said step of using a monolithic organic polymer includes a copolymerization being a thermally initiated free radical copolymerization.

28. The method according to claim 10, wherein said step of using a monolithic organic polymer includes a copolymer in the form of particles having a diameter in the range of about 2-50 μm.
